(19) United States
(12) Patent Application Publication
(10) Pub. No.: US 2003/0046916 A1
(43) Pub. Date: Mar. 13, 2003

(54) Beater rod and beater rod assembly for a harvester

(76) Inventor: Wilbert E. Rojewski, San Mateo, CA (US)

Correspondence Address: Pennie & Edmonds, LLP, 3300 Hillview Avenue, Palo Alto, CA, 94304, US

(21) Appl. No.: 09/949,471

(22) Filed: Sep. 7, 2001

(51) Int. Cl. A01D 46/00

(52) U.S. Cl. 56/330

(57) ABSTRACT

The present invention provides a beater rod assembly for a harvester comprising a central shaft configured at one end for attachment to a harvester and a plurality of beater rods, each comprising an elongated shaft having a first end attached to the central shaft and extending radially outward from the central shaft, wherein the elongated shaft of at least one of the beater rods comprises a rigid portion extending from the first end of the elongated shaft to an intermediate location along the elongated shaft and a flexible portion extending from the intermediate location to a second end of said elongated shaft.

### BACKGROUND OF THE INVENTION

1. Field of the Invention

The invention relates generally to harvesters used to collect agricultural produce. More specifically, the invention is directed to a beater rod and a beater rod assembly used in a harvester for engaging trees or plants, such as bushes or vines, to separate produce or fruit, such as berries or grapes, from the trees or plants.

2. Description of Related Art

Harvesters are used to collect produce, such as berries, grapes, coffee, olives, etc. that is grown in rows of trees or plants, including, for example, annual row crops. Such harvesters are driven or pulled down a path between each row and mechanically engage the adjacent trees or plants to dislodge or separate the fruit from the trees or plants. More typically, as the harvester is driven down a path between two adjacent rows of trees or plants, one side of the harvester engages one row of trees or plants, and the opposite side of the harvester engages the adjacent row of trees or plants on the opposite side of the harvester. Of course, the harvester is only engaging one side of a given row of trees or plants at a time. As the harvester is driven down an adjacent path it would then engage the other side of that given row of trees or plants. Alternatively, a harvester may straddle a single row of plants and engage both sides of that row of plants at the same time.

One method for mechanically engaging the trees or plants is by using a beater rod assembly. Such an assembly comprises a central shaft having a plurality of beater rods that extend radially from the central shaft. The beater rods are typically evenly spaced around the circumference of the central shaft, as well as axially along the central shaft. The individual beater rods are typically made of fiberglass and polyester. Fiberglass is used to impart significant strength and rigidity to the beater rod at a relatively low cost, and the polyester is used to contain the fiberglass.

The central shaft is connected to the harvester such that it is free to rotate about its longitudinal axis. More specifically, the central shaft may be positioned on top of a set of bearings that allow it to freely rotate. The beater rod assembly is positioned relative to the trees or plants such that the beater rods connected to the central shaft extend into or engage the trees or plants. As the harvester is driven, the beater rods engage the trees or plants, which, in turn, results in rotation of the central shaft about its longitudinal axis. The position of the beater rod assembly relative to the harvester may be such that the beater rods are parallel to the ground or at an angle to the ground so long as efficient engagement of the trees or plants is accomplished.

In addition, a cam mechanism is used to move the central shaft up and down in an axial direction as the beater rods are rotating. Therefore, as the beater rods are rotating they are also being moved back and forth in a direction that is approximately normal to the plane in which they are rotating. The distance that the beater rods are moved by the cam mechanism is typically on the order of a few inches, and the speed at which the beater rods are moved is set by the cam but can be on the order of several hundred oscillations per minute, for example, 450 oscillations per minute. In addition, the beater rod can be attached to the central shaft in such a manner to allow movement of the beater rods in different directions thereby causing the tip of the beater rod to follow a circular or oval pattern in addition to the motion produced from its rotation.

During operation, the movement of the beater rods forcefully engages the tree branches or plant vines to dislodge the fruit. In addition, the beater rods may also engage the fruit itself and dislodge it. The fruit is then caught by a basket or conveyor-like assembly attached to the harvester and positioned underneath of the beater rod assembly. However, as a result of the beater rods continually impacting the tree branches or plant vines, or stakes or posts that have been positioned within the matrix of tree branches or vines to assist in their growth, the beater rods suffer significant stresses, particularly when a beater rod cannot easily slide by a branch or vine, or stake or post, and, for example, becomes lodged between multiple branches or vines. These stresses may, in fact, result in the beater rod becoming significantly worn. For example, the polyester may simply wear off of the beater rod such that the glass fibers become frayed. More significantly, the beater rods may actually break or snap along its shaft if it becomes caught and is unable to bend sufficiently to disengage, which may also cause significant damage to a branch or vine. In this case, the damaged beater rod is simply replaced in the field typically by hammering a replacement rod into a hole of a collar attached to the central shaft.

As such, beater rods must be continually replaced at significant expense and downtime. Therefore, there exists a need for an improved beater bar assembly and beater rod having improved durability and resistance to breakage.

### SUMMARY OF THE INVENTION

Accordingly, the present invention provides a beater rod that has improved resistance to breakage and improved durability. In addition, the present invention provides a beater rod assembly for a harvester that uses the beater rod of the present invention to reduce the necessity of replacing failed beater rods in the field during operation.

These and other benefits are provided by the present invention which, in one embodiment, comprises a beater rod for a harvester beater rod assembly comprising an elongated shaft having a first end and a second end and configured at the first end for attachment to a harvester beater rod assembly, wherein the elongated shaft comprises a rigid portion extending from the first end to an intermediate location along the elongated shaft and a flexible portion extending from the intermediate location to the second end.

In addition, the present invention comprises, in another embodiment, a beater rod assembly for a harvester comprising a central shaft configured at one end for attachment to a harvester and a plurality of beater rods, each comprising an elongated shaft having a first end attached to the central shaft and extending radially outward from the central shaft, wherein the elongated shaft of at least one of the beater rods comprises a rigid portion extending from the first end of the elongated shaft to an intermediate location along the elongated shaft and a flexible portion extending from the intermediate location to a second end of said elongated shaft.

These and other objects and features of the invention will appear from the following description from which the preferred embodiments are set forth in detail in conjunction with the accompanying drawings.

### BRIEF DESCRIPTION OF THE DRAWINGS

FIG. 1 is a side view of a beater rod assembly according to one embodiment of the present invention;

FIG. 2 is a top view of a beater rod assembly according to one embodiment of the present invention;

FIG. 3 is a side view of a beater rod according to one embodiment of the present invention;

FIG. 4 is a side view of a beater rod according to another embodiment of the present invention; and

FIG. 5 is a side view of a beater rod according to another embodiment of the present invention.

### DETAILED DESCRIPTION OF THE PREFERRED EMBODIMENTS

The structure and function of the preferred embodiments can best be understood by reference to the drawings. The reader will note that the same reference designations appear in multiple locations. Where this is the case, the numerals refer to the same or corresponding structure in each of those locations.

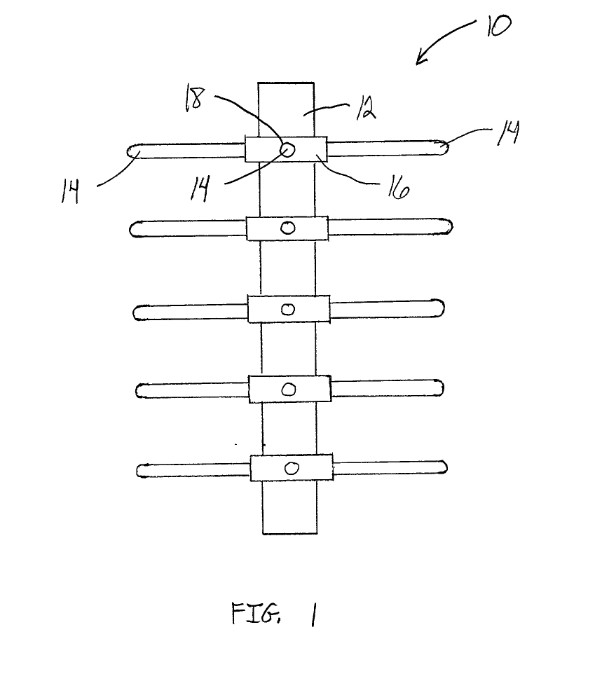

FIG. 1 is a side view of a beater rod assembly according to one embodiment of the present invention. Beater rod assembly 10 comprises a central shaft 12 that is configured at one end to be attached to a harvester. Preferably, the central shaft 12 is configured at this end to permit it to freely rotate about its own longitudinal axis, for example by resting on a set of bearings on the harvester. Additionally, the central shaft 12 is configured at this same end to engage a cam mechanism (not shown) that acts to move the central shaft back and forth in an axial direction.

Attached to central shaft 12 is a plurality of beater rods 14. Collars 16 are used to attach the beater rods 14 to the central shaft 12. Typically the collars 16 comprise two semi-circular pieces which when connected fit completely around the central shaft 12. The collar 16 is typically configured as a clamp such that it is clamped in place about the central shaft 12; however, one of skill in the art will appreciate that any method may be used to fixedly attach the collars 16 to the central shaft 12, for example, by using bolts or screws. The beater rods 14 are typically inserted into holes 18 positioned in and around the collars 16. The beater rods 14 are inserted in the holes by applying a force to the outer end of the beater rods 14 such that a friction fit secures the beater rods 14 to the collar 16. In addition or alternatively, an adhesive may be used to secure the beater rods 14 to the collar 16. One of skill in the art will appreciate that any other method known in the art may be used to fixedly attach the beater rods 14 to the central shaft 12. The beater rods 14 are typically evenly spaced around the circumference and along the length of the central shaft 12 as desired or as demanded by the specific application or harvest being performed. Typically, each row of beater rods 14 is spaced 2-4 inches apart along the length of the central shaft 12. The number of beater rods 14 connected to the central shaft 12 may also be altered as desired or as demanded by the specific application or harvest being performed. In a preferred embodiment, the number of collars 16 used may range from 6-20, and the number of beater rods 14 attached to each collar may range from 12-18.

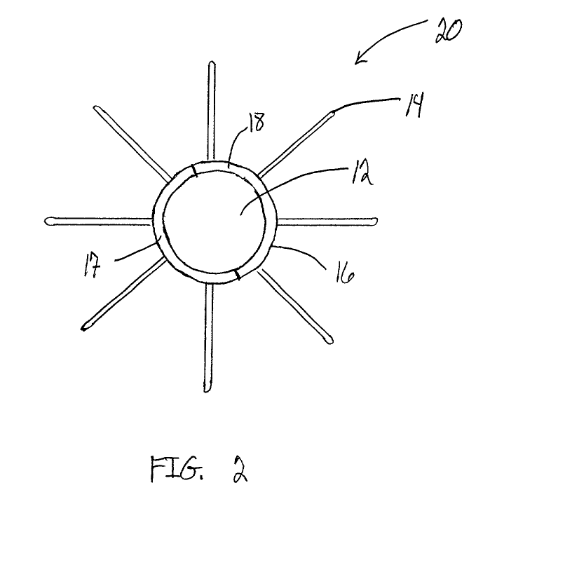

FIG. 2 is a top view of a beater rod assembly according to one embodiment of the present invention. The beater rod assembly 20 comprises a central shaft 12 and a plurality of beater rods 14. Collar 16 is used to connect the beater rods 14 to the central shaft 12. As noted above, collar 16 typically comprises two semi-circular pieces 17, 18, which when connected fit completely around the central shaft 12. As shown, the beater rods 14 are positioned around the circumference of the central shaft 12. Again, the number of collars 16 and the number of beater rods 14 may be varied as desired.

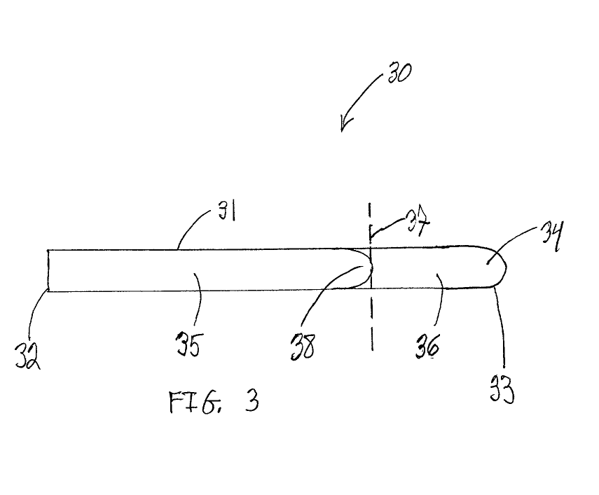

FIG. 3 is a side view of a beater rod according to one embodiment of the present invention. It should be appreciated that this beater rod may be used in any beater rod assembly and is not limited to the beater rod assemblies described in connection with FIGS. 1 and 2. The beater rod 30 comprises an elongated shaft 31 having a first end 32 and a second end 33. The overall length of the beater rod 30 may be varied depending upon its ultimate use, including the specific type of fruit to be harvested, the condition of the tree branches or plant vines, such as the density of the branches or vines, and the size of the branches or vines. However, a preferred length is from approximately 18-22 inches, and a more preferred length is approximately 20 inches. In addition, the weight of the beater rod 30 may also be varied depending upon its intended use. For example, a heavier beater rod 30 may be desired when a more forceful or aggressive engagement with the tree or plant is desired. The weight of the beater rod 30 may be altered primarily based upon its materials of construction, the selection of which is described in more detail below.

The diameter of the beater rod 30 may also be selected to fit a particular need; however, the diameter at least at the first end 32 must be such that it is capable of being fixedly connected to the central shaft or collar of the beater rod assembly. For example, the diameter must be such that if used in connection with a collar, it is capable of fitting within the hole provided by the collar. For example, the first end 32 may simply be configured to provide a friction or tight fit in a hole of a collar that is attached to a central shaft of any beater rod assembly. In this case, the beater rod 30 is simply inserted into the hole in the collar by the application of force, such as hammering. A preferred outer diameter, however, for the beater rod 30 is approximately ⅜-½ inches, and a more preferred outer diameter is either approximately ⅜ or approximately ½ inches.

The second end 33 of the beater rod 30 has a contoured tip 34. The term “contoured” is used in its broadest sense to describe any geometry or shape other than a flat end at the second end 33 of the beater rod 30. Preferably, the contoured tip 34 is configured in a shape that assists in permitting the beater rod 30 to more easily engage and disengage, or slide by branches or vines, or stakes or posts, to avoid becoming caught or locked in place within the trees or plants being engaged by the beater rod 30. For example, the contoured tip 34 may take a rounded or spherical shape, a bullet-nosed shape, an oval shape, a tapered shape, a pointed shape, a conical shape, a pyramid shape, a frustrum shape, a frusto-conical shape, a frusto-spherical shape, a parabolic shape, etc. Particularly preferred is a bullet-nosed shape, which is intended to be in the shape of the nose of a bullet.

As noted, this contoured tip 34 provides the ability of the beater rod 30 to more easily engage or slide into the tree or plant and to more easily disengage from the tree or plant. This contoured tip 34 may be generated by any method known in the art depending upon the materials of construction used, which is discussed in more detail below. For example, this contoured tip 34 may be generated by casting, sanding, or grinding, again depending upon the actual materials of construction. The size of the contoured tip 34 is preferably designed such that its length, that is the length as measured axially along the beater rod 30 from the point where the tip begins to take shape to its terminus, is greater than the diameter of the beater rod 30.

The beater rod 30 is constructed to have two regions or portions: a rigid portion 35 and a flexible portion 36. The rigid portion 35 may be constructed of any material that provides strength and rigidity to that portion of the beater rod 30, such as fiberglass or steel. (The use of steel in the rigid portion 35 is further described below in connection with another embodiment of the present invention.) The length of the rigid portion 35 extends from the first end 32 of the beater rod 30 to an intermediate location 36 along the elongated shaft 31 of the beater rod 30.

However, the length of the rigid portion 35 may be altered depending upon the overall length of the beater rod 30, the length of the flexible portion 36, and the intended use for the beater rod 30. One of skill in the art will appreciate that, depending upon the fruit to be harvested and the type of branches or vines to be engaged, the beater rod 30 may be designed to more or less aggressively engage a branch or vine. For example, one may desire a longer or shorter rigid portion 35 relative to the flexible portion 36. If the beater rod 30 is going to be used to aggressively engage a branch or vine, a longer rigid portion 35 may be more desirable to allow for more efficient transfer of energy to the branch or vine upon impact. Alternatively, if the fruit to be harvested or the particular branches or vines to be engaged may be damaged by aggressive engagement with the beater rod 30, a shorter rigid portion 35 may be desirable. Of course, one of skill in the art will appreciate the interaction of the beater rod 30 design with the rate at which the central shaft is oscillated by the cam mechanism to determine the appropriate beater rod 30 design and cam oscillations to provide the desired amount of aggressive engagement with the branches or vines. Preferably, however, the rigid portion 35 is approximately 13-15 inches in length, and more preferably the rigid portion 35 is 14 inches in length.

In a preferred embodiment, the end of the rigid portion 34 (i.e., the end at the intermediate location 36) also comprises a contoured tip 38. As will be discussed below, this contoured tip 38 facilitates connection of the flexible portion 36 to the rigid portion 35. This contoured tip 38 may be formed in a manner similar to the contoured tip 34 at the second end 33 of the beater rod 30. For example, this contoured tip 38 may be generated by casting, sanding, or grinding, again depending upon the actual materials of construction. Preferably, this contoured tip 38 is also designed to take a bullet-nosed shape, but it should be appreciated that any shape for this contoured tip 38 may be used, provided such shape facilitates the connection of the flexible portion 36 to the rigid portion 35.

The flexible portion 36 extends from the intermediate location 37 to the second end 33. By attaching the flexible portion 36 to the rigid portion 34, the beater rod 30 has the capability of flexing or bending as it engages or moves through the trees or plants and may thereby reduce the possibility of breakage upon engaging the trees or plants. For example, if the beater rod 30 engages a dense portion or thick matrix of tree branches or plant vines and becomes caught therein, the flexibility of the beater rod 30 at its second end 33 would allow the beater rod 30 to flex and enhance its ability to disengage from the branches or vines.

In addition, the flexible portion 36 of the beater rod 30 increases the area over which the beater rod 30 traverses during its rotation and movement imparted by the cam mechanism. More specifically, since the cam mechanism imparts a back and forth oscillation, the momentum at the second end 33 of the beater rod 30 will be greater with the flexible portion 36 compared to a beater rod with a second end that is rigid. As such, the second end 33 of the beater rod will flex during the oscillation and traverse a larger area as it engages the tree or plant, which may result in greater efficiency of the harvester in dislodging fruit.

The flexible portion 36 may be constructed of any material that provides the ability of the flexible portion 36 to bend relative to the rigid portion 34, such as a urethane material. One of skill in the art will appreciate that other plastics or rubbers may be used as well. As noted above, one of skill in the art will appreciate that various methods may be used to generate the contoured tip 34 of the flexible portion 36 based upon the actual materials of construction used for the flexible portion 36. For example, if the flexible portion 36 is made of urethane, simple casting, sanding, or machining techniques can be used to generate the contoured tip 34.

The length of the flexible portion 36 may be altered depending upon the overall length of the beater rod 30, the length of the rigid portion 35, and the intended use for the beater rod 30. As noted above, one of skill in the art will appreciate that, depending upon the fruit to be harvested, the beater rod 30 may be designed to more or less aggressively engage a branch or vine, depending in part on the oscillations of the cam mechanism and the rate at which the beater rod is oscillated. Therefore, one may desire a longer or shorter flexible portion 36 relative to the rigid portion 35. For example, if the beater rod 30 is going to be used to aggressively engage a branch or vine, a shorter flexible portion 36 may be more desirable to allow for more efficient transfer of energy to the branch or vine upon impact. Alternatively, if the branches or vines to be engaged by the beater rod 30 are particularly dense, then a longer flexible portion 36 may be desired. Preferably, however, the flexible portion 36 is approximately 5-7 inches in length, and more preferably the flexible portion 36 is 6 inches in length.

Depending upon the materials of construction of both the rigid portion 35 and the flexible portion 36, various methods for attaching the flexible portion 36 to the rigid portion 35 may be used. For example, if the rigid portion 35 is made of fiberglass and the flexible portion 36 is made of urethane, one of skill in the art will appreciate that various known adhesives may be used to glue the flexible portion 36 to the rigid portion 35. For example, a primer, preferably a urethane-based primer in the case where the flexible portion 36 is urethane, may be used to coat either the flexible portion 36, the rigid portion 35, or both at those locations where the two portions 35, 36 will mate to aid in the adhesion of the two portions 35, 36. Alternatively, the two portions 35, 36 may be cast together, or the flexible portion 36 may be attached to the rigid portion 35 using various fasteners known in the art.

In a preferred embodiment, and as shown in FIG. 3, the flexible portion 36 also extends in the opposite direction from the intermediate location 37 such that it surrounds the contoured tip 38 at the end of the rigid portion 35. By configuring the terminal end of the rigid portion 35 as a contoured tip 38, more surface area is provided, compared to a flat end, for connection of the flexible portion 36. So, for example, if an adhesive is used to connect the flexible portion 36 to the rigid portion 35, there is more surface area available for contacting between these two portions if the rigid portion 35 comprises a contoured tip 38 compared to a rigid portion that simply has a flat end. By extending the flexible portion 36 along an axial length of the rigid portion 35, stresses imparted to the beater rod 30 are dissipated axially and are not concentrated at the junction of the two portions 35, 36.

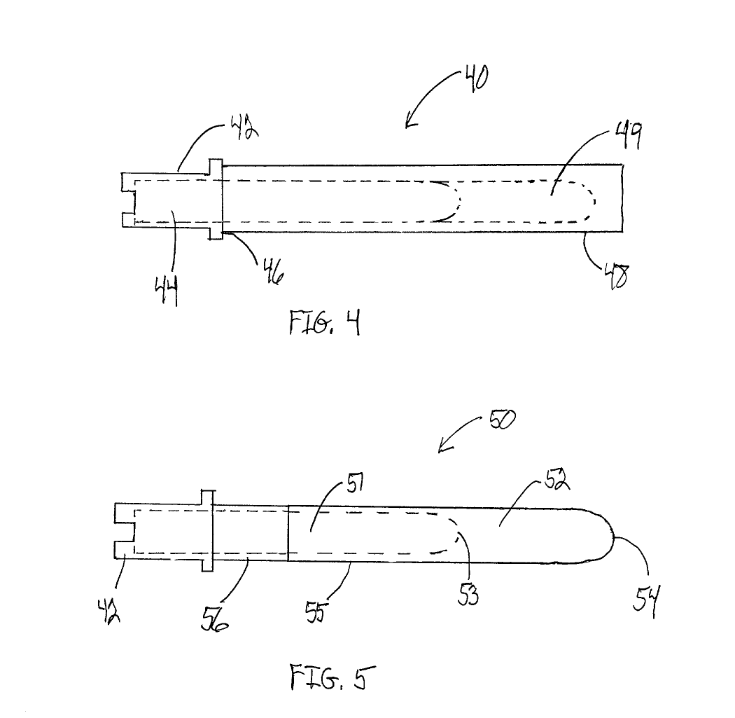

FIG. 4 is a side view of a beater rod according to another embodiment of the present invention. In this embodiment, the beater rod 40 is essentially the same as the beater rod 30 shown in connection with FIG. 3 with the addition of a bushing 42 positioned near the second end 44 of the beater rod 40. As previously described, the second end of the beater rod is configured to connect to a central shaft of a beater rod assembly. Also, as described previously, one type of connection used is a friction fit in a hole provided by a collar attached to the central shaft. In this case, the bushing 42 is a cylindrical body attached to the second end 44 of the beater rod 40 to enhance the friction fit of the beater rod 40 in the hole provided by the collar attached to the central shaft. In this case, the bushing 42 may be attached to the second end 44 by any means known in the art and may be made from plastic, metal, or any composite material.

The bushing 42 also provides an edge 46 that extends beyond the radius of the beater rod 40. This provides for the use of a separate tube 48 that has an inner diameter greater than the outer diameter of the beater rod 40 but less than the outer diameter of the edge 46 provided by the bushing 42. This tube 48 is, therefore, capable of sliding over the beater rod 40 from its first end 49 until it abuts the edge 46 of the bushing 42. The length of this tube 48 is preferably such that when in position against the edge 46, it extends beyond the first end 49 of the beater rod 40. With this tube in place against the edge 46, a hammer or other device may be used to impart an impact on the opposite end of this tube 48 to drive the beater rod 40 and the bushing 42 into a hole in the separate collar attached to a central shaft. Alternatively, the tube 48 may simply be used as a hammer itself to push the beater rod 40 into the hole in the collar on the central shaft. In this case, it would not be necessary for the tube 48 to be of a length that would extend beyond the first end 49 of the beater rod 40.

In this embodiment, the outer diameter of the bushing 42 is selected to provide the necessary friction fit in the hole of the separate collar on the central shaft. A preferred outer diameter for the bushing 42 is ½ inches with an outer diameter of the edge 46 being ¾ inches. In this case, a preferred outer diameter for the beater rod 40 is ⅜ inches. A preferred length for the bushing 42, including the length of the edge 46, measured in a direction axial to the beater rod 40 is 2 and ⅜ inches, with the length of the edge 46 being ⅜ inches.

FIG. 5 is a side view of a beater rod according to another embodiment of the present invention. In this embodiment, the beater rod 50 comprises a rigid portion 51 constructed of a metal and a flexible portion 52 constructed of any flexible material. Preferably, the rigid portion 51 is constructed of steel or fiberglass (or a fiberglass polyester material), and the flexible portion 52 is constructed of a urethane material. In this embodiment, as described in connection with other embodiments above, both the rigid portion 51 and the flexible portion 52 have contoured tips 53, 54, respectively. In addition, a cover 55, preferably integral to the material used to construct the flexible portion 52, extends over and covers a significant portion of the rigid portion 51. It should be appreciated, however, that this cover 55 may be separate from the flexible portion 52 and constructed to mate with the flexible portion 52 so that the outer surface of the beater rod 50 is generally smooth. Cover 55, particularly when it is integral to the flexible portion 52, acts to make the beater rod 50 smooth and thereby may result in less damage to the engaged tree or plant.

As also described in connection with FIG. 4, a bushing 42 may also be included in this embodiment. In addition, reinforcement sleeve 56 is positioned next to, and may be constructed to be integral with, the bushing 42. This reinforcement sleeve 56 is a cylindrical body that fits around the beater rod 50 and acts to strengthen the beater rod 50 where it will be connected to a collar on the central shaft. During operation, significant force is exerted on the beater rod as it engages tree branches or plant vines, and this force is translated to the point where the beater rod 50 is connected to the central shaft. As such, this connection is subject to fatigue and failure. Therefore, the use of this reinforcement sleeve 56 acts to reduce the amount of fatigue at this portion of the beater rod 50 and distributes or dissipates this stress radially about the beater rod 50 to avoid breakage at this location due to heat build up caused by the rapid bending at this one point.

The reinforcement sleeve 56 may be attached to the beater rod 50 by any means known in the art and may be made from plastic, metal, or any composite material suitable for providing the desired amount of reinforcement or fatigue or stress reduction. Preferably, the reinforcement sleeve 56 is constructed integrally with the bushing 42 or may be an attached extension of the bushing 42. It should be appreciated that both the collar 42 and the reinforcement sleeve 56 may each be used together or separately with any of the beater rod embodiments described herein.

Preferably, the reinforcement sleeve 56 has the same outer diameter as the bushing 42, which is preferably ½ inches. The length of the reinforcement sleeve 56 may be altered depending upon the ultimate intended use of the beater rod 50. For example, if the beater rod 50 will be used to engage a particularly dense matrix of tree branches or plant vines, a longer reinforcement sleeve 56 may be desired. Preferably, however, the reinforcement sleeve is approximately 2 inches in length, measured axially along the beater rod 50.

While the foregoing description and drawings represent the preferred embodiments of the present invention, it will be understood that various additions, modifications and substitutions may be made therein without departing from the spirit and scope of the present invention as defined in the accompanying claims. The presently disclosed embodiments are, therefore, to be considered in all respects as illustrative and not restrictive, the scope of the invention being indicated by the appended claims and not limited to the foregoing description.

What is claimed is:

1. A beater rod assembly for a harvester, comprising:
a central shaft configured at one end for connection to a harvester; and
a plurality of beater rods, each comprising an elongated shaft having a first end attached to said central shaft and extending radially outward from said central shaft;
wherein said elongated shaft of at least one of said beater rods comprises a rigid portion extending from said first end of said elongated shaft to an intermediate location along said elongated shaft and a flexible portion extending from said intermediate location to a second end of said elongated shaft.

2. The beater rod assembly of claim 1, wherein said rigid portion comprises fiberglass and said flexible portion comprises urethane.

3. The beater rod assembly of claim 2, wherein said rigid portion further comprises a contoured tip at said intermediate location and said flexible portion is bonded to said contoured tip.

4. The beater rod assembly of claim 1, wherein said rigid portion comprises a steel shaft having an outer urethane coating disposed axially around said steel shaft, and said flexible portion comprises urethane.

5. The beater rod assembly of claim 4, wherein said outer urethane coating and said flexible portion comprising urethane comprise an integral urethane body.

6. The beater rod assembly of claim 4, wherein said steel shaft comprises a contoured tip.

7. The beater rod assembly of claim 1, wherein said elongated shaft of at least one of said beater rods further comprises a contoured tip at said second end of said elongated shaft.

8. The beater rod assembly of claim 1, wherein said elongated shaft of at least one of said beater rods further comprises a reinforcement sleeve disposed axially around said elongated shaft and extending a predetermined length from said first end.

9. The beater rod assembly of claim 1, wherein said elongated shaft of at least one of said beater rods further comprises a bushing disposed around said elongated shaft and adjacent to said first end, wherein at least a portion of said bushing extends radially a predetermined distance from said elongated shaft.

10. The beater rod assembly of claim 9, further comprising a hollow tube having an inner diameter greater than a outer diameter of said elongated shaft of at least one of said beater rods and less than an outer diameter of said portion of said bushing and having a length greater than a distance from said portion of said bushing to said second end of said elongated shaft.

11. A beater rod for a harvester beater rod assembly, comprising:
an elongated shaft having a first end and a second end and configured at said first end for attachment to a harvester beater rod assembly, wherein said elongated shaft comprises a rigid portion extending from said first end to an intermediate location along said elongated shaft and a flexible portion extending from said intermediate location to said second end.

12. The beater rod of claim 11, wherein said rigid portion comprises fiberglass and said flexible portion comprises urethane.

13. The beater rod of claim 12, wherein said rigid portion further comprises a contoured tip at said intermediate location and said flexible portion is bonded to said contoured tip.

14. The beater rod of claim 11, wherein said rigid portion comprises a steel shaft having an outer urethane coating disposed axially around said steel shaft and said flexible portion comprises urethane.

15. The beater rod of claim 14, wherein said outer urethane coating and said flexible portion comprising urethane comprise an integral urethane body.

16. The beater rod of claim 14, wherein said steel shaft comprises a contoured tip.

17. The beater rod of claim 11, wherein said elongated shaft further comprises a contoured tip at said second end of said elongated shaft.

18. The beater rod of claim 11, wherein said elongated shaft further comprises a reinforcement sleeve disposed axially around said elongated shaft and extending a predetermined length from said first end.

19. The beater rod of claim 11, wherein said elongated shaft further comprises a bushing disposed around said elongated shaft and adjacent to said first end, wherein at least a portion of said bushing extends radially a predetermined distance from said elongated shaft.

20. The beater rod of claim 19, further comprising a hollow tube having an inner diameter greater than an outer diameter of said elongated shaft and less than an outer diameter of said portion of said bushing and having a length greater than a distance from said portion of said bushing to said second end of said elongated shaft.

21. A beater rod for a harvester beater rod assembly, comprising:
an elongated shaft having a first end and a second end and configured at said first end for attachment to a harvester beater rod assembly, wherein said elongated shaft comprises a rigid portion extending from said first end to an intermediate location along said elongated shaft and a flexible portion extending from said intermediate location to said second end and wherein said rigid portion comprises a rigid portion contoured tip at said intermediate location and said flexible portion comprises a flexible portion contoured tip at said second end.

22. The beater rod of claim 21, wherein said rigid portion contoured tip and said flexible portion contoured tip are each bullet-nose shaped.

23. The beater rod of claim 22, wherein said rigid portion comprises fiberglass and said flexible portion comprises urethane.
